(19) United States
(12) Patent Application Publication
(10) Pub. No.: US 2009/0276347 A1
(43) Pub. Date: Nov. 5, 2009

(54) METHOD AND APPARATUS FOR USE OF A TEMPORARY FINANCIAL TRANSACTION NUMBER OR CODE

(76) Inventor: James B. Kargman, Chicago, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/434,296

(22) Filed: May 1, 2009

Related U.S. Application Data
(60) Provisional application No. 61/049,586, filed on May 1, 2008.

(51) Int. Cl. G06Q 20/00

(52) U.S. Cl. 705/35

(57) ABSTRACT

A temporary financial transaction number is generated for conducting a financial transaction, such as for paying for goods or services. The temporary number has limits on use, such as time, and amount limits and limits on the type of goods or services that may be purchased or on the type of business at which the purchase may be made. The limits may be encoded into the temporary number or otherwise linked to the number. User identification information, or information on other authorized users, may also be encoded into the number or otherwise linked to the number. When presented for a payment, the number is checked for validity as well as whether the purchase is within the limits. An authorized purchase is applied against a user bank account or credit card account without disclosure of the account information. The temporary number is printed or is displayed on a display of a portable electronic device for presentation to the seller, or is transmitted to the seller for on-line purchases.

### CROSS-REFERENCE TO RELATED APPLICATION

This application claims the benefit of U.S. Provisional Patent Application Ser. No. 61/049,586, filed May 1, 2008, which is incorporated herein by reference.

### BACKGROUND OF THE INVENTION

1. Field of the Invention

The present invention relates generally to a method and apparatus for using a number, or code embedding a number, that is presented for authorizing purchases of goods and service or for use in other financial transactions.

2. Description of the Related Art

Gift cards are regularly issued by stores and businesses, wherein a purchaser of the gift card puts a value on the card, and the recipient of the gift cart can use the card up to the designated value. Use of the gift card is limited to the store or business that issued the card. Validation of the gift cards is by writing the value of the card to a magnetic stripe on the back of the card when the card is purchased by the purchaser and reading the magnetic strip at the store when a purchase is made by the gift card recipient.

Credit card companies provide users with credit cards that have account numbers marked on the cards. Use of the credit card, either by presenting the card to a store or restaurant or by transmitting the account number to a vendor on-line, results in a fee being charged to the store, restaurant or vendor for using the credit card service. Credit card companies have begun to issue gift cards that are accepted at stores there the credit card of the issuing company is accepted. A percentage is charged up front for purchasing the gift card from the credit card company, so that the fee is already taken out before the gift card is used.

### SUMMARY OF THE INVENTION

The present invention provides a method and apparatus for generating a temporary financial transaction number and for use of a temporary financial transaction number to perform financial transactions. A user generates or obtains a temporary number that is authorized for purchases or costs within limits, wherein the limits are preferably set by the user. The user sets the limits and requests the temporary number. The temporary transaction number preferably incorporates the limits set by the user. The user, or a recipient of the number authorized by the user, presents the temporary number, as a number or as a machine readable code encoding the number, to a store, business or other seller as a payment. The store, business or seller obtains authorization to submit the purchase price or payment against the temporary transaction number. If the purchase price or payment is within the limits, the payment to the seller is approved. The purchase price or payment is applied against the user's credit card, bank account, or other account without revealing the credit card number or bank account number to the seller.

The user set limits may be a limit as to an amount of a single purchase or payment, a limit on cumulative purchases or payments, a time limit, such as an expiration time, a limit on times of the day, on days of the week or other time limits within which purchases are authorized, a limit as to the recipient that may receive the payment or on a type or location of recipient or business that may receive the payment or other criteria for the recipient of the payment. Other limits are also possible.

The present invention also provides an apparatus for generating the temporary financial transaction number, and apparatus of requesting a previously generated temporary number, as well as an apparatus as a carrier medium for the user to carry so that the temporary transaction number may be used when needed. In one embodiment, the carrier apparatus is a credit card-sized card that includes the temporary financial transaction number for presentation to a vendor to purchase goods or services while in another embodiment the carrier medium is a portable electronic device having an electronic display, such as on a mobile telephone, on which the temporary transaction number is displayed, for instance as a machine readable code. The present invention also provides an apparatus and system generating temporary transaction numbers, for storing temporary transaction number, for validating the temporary transaction numbers and authorizing payment using a temporary financial transaction number, as well as for applying the payment to a user account.

### BRIEF DESCRIPTION OF THE DRAWINGS

FIG. 1 is a flow chart showing a method for obtaining a temporary financial transaction number, according to one embodiment;

FIG. 2 is a flow chart showing a method for authorizing use of a temporary financial transaction number;

FIG. 3 is a functional block diagram of a system or apparatus for obtaining and using the temporary financial transaction numbers; and

FIG. 4 is a sample grid code for encoding a temporary transaction number for use on a carrier medium.

### DETAILED DESCRIPTION OF THE PREFERRED EMBODIMENTS

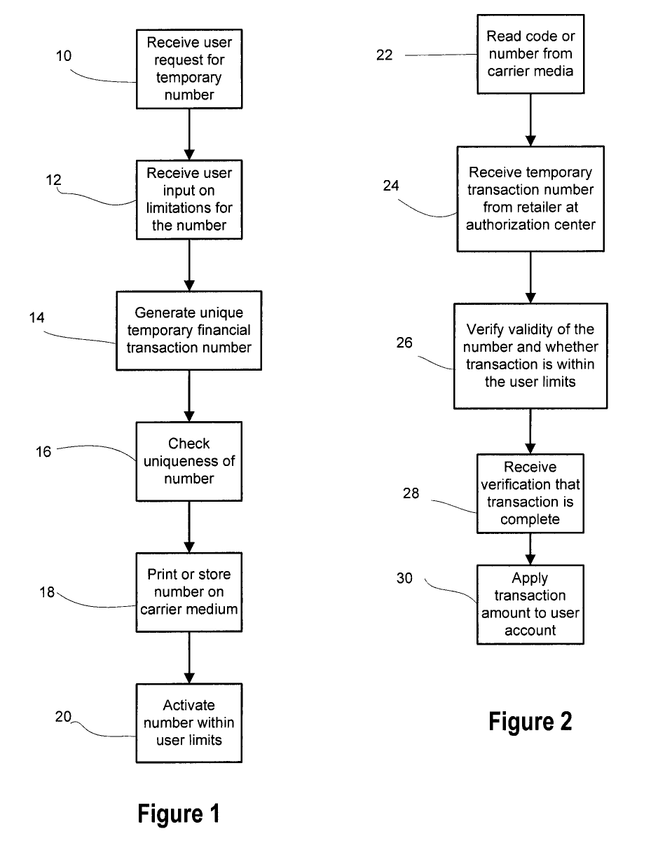

In FIG. 1 is shown a method for obtaining a temporary transaction number according to an embodiment of the invention. In a first step 10, a user requests a temporary transaction number and inputs that request to an apparatus or system for generating the number. The number may be generated locally or the number may be generated remotely, in which case the request is transmitted by the local apparatus or system to a remote a system or apparatus that generates the number. The temporary transaction number may be generated following receipt of the request or the temporary number may have been previously generated and stored, either in the local device or in the remote apparatus. The temporary transaction number of a preferred embodiment includes a base number to which is applied additional data such as limit data and identification data. The previously generated temporary numbers may include only the base number.

The temporary transaction number is obtained for limited use as determined by the user. The user inputs limits and restrictions to be applied to the temporary transaction number, at step 12. Where the temporary number is generated remotely, the limits are transmitted from the local apparatus to the remote apparatus. The apparatus or system generates a temporary transaction number at step 14, utilizing software and/or firmware on the apparatus or system. The limits input by the user are applied to or linked to the temporary transaction number. The limits may be applied to a base number as additional digits encoding the limits or by modifying the base number itself. User identification information may also be applied or linked to the number. Some or all of the limits and identification data may be linked to the temporary number in a database, for example. Preferably, some or all of the limit data and identification is applied as a modification or addition to the base temporary number.

A further step is to check the temporary transaction number to insure that it is a unique number, at least as to the transaction number system, as shown at step 16. The temporary transaction number is printed on or otherwise provided to a carrier medium which carries the temporary number, at step 18. The carrier medium may be paper, credit card type card, or other printable medium or may be an electronic display, electronic paper, or other display medium on which to display the temporary number. As an alternative, the carrier medium may be an electronic storage, memory or other electronic device in which the temporary number is stored and that is readable via a wired or wireless reader. The temporary transaction number is activated within the predetermined limits in step 20.

In FIG. 2, the user, or a person to whom the user has provided the temporary transaction number, is seeking to make a payment, such as for the purchase of goods or services, payment of a bill or other financial transaction. The user or other person presents the carrier medium that has the temporary transaction number to the seller and the temporary transaction number is read from the carrier medium, at step 22. Reading of the carrier medium can be performed by an optical reader, by an electrical or electromagnetic reader, or by manual input, or by other means. At step 24, the seller, who in the example is a retail seller of goods, transmits the temporary transaction number to an authorization center for approval. User identification data may also be transmitted. Upon receipt of the temporary transaction number, the authorization center verifies the validity of the temporary transaction number and determines whether the use is within the limits applied or linked to the number, at step 26. This may include checking the received number against established valid numbers stored in the system, and checking limit criteria against the limits for the received number. If identification data has been transmitted, the identification data is checked for validity as well. Once the validity of the number is established and it has been determined that the transaction is within the limits, an authorization for the financial transaction is forwarded to the seller. If the received transaction number is not a valid number or if the transaction is outside the limits established for the number, the authorization request is declined. If the identification data does not agree with the identification data for this number, the transaction request may also be declined.

After the authorization for the transaction has been sent to the seller, a verification is provided by the seller, for example, that the transaction between the buyer and seller has been completed, as shown in step 28. The amount of the transaction is applied to an account of the user, at step 30. The application of the amount to the user account may performed following receipt of the verification from the seller that the transaction between the buyer and seller has been completed, or may be performed upon authorization of the transaction. The payment is deducted from the user's bank account or applied to the user's credit card or other account.

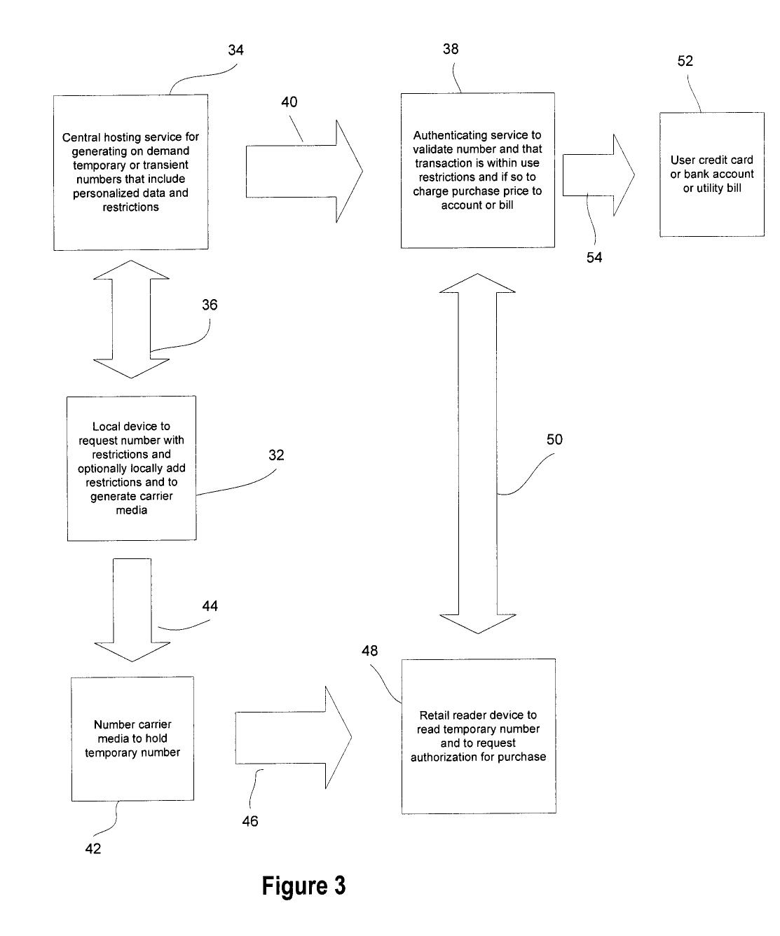

In FIG. 3, a system for generating and using the temporary financial transaction number is shown. The system includes a local device 32 for use by the user. The local device 32 is accessed by the user to request a temporary transaction number and to input limits to be applied to or linked to the temporary transaction number. An optional function of the local device 32 is to locally add restrictions or limits to the transaction number. In one embodiment, the local device 32 provides a carrier medium with the temporary transaction number, such as by printing, electronic storage, electromagnetic storage, or otherwise.

The local device 32 may be a user's computer, mobile telephone, a portable electronic device, or other computer or non-computer device, or may be a kiosk at a business, store or mall, or a terminal at a business or other location. Such devices include at least one processor, memory and storage devices, a display and user inputs such as keyboards or keypads and pointers such as a mouse or joystick device. Other configurations of such devices are possible as well and are included here. The local device 32 may include specialized software or firmware, such as for generation of the temporary transaction number locally, or may use general purpose software, such as browser or other communications software, for obtaining the transaction number form a centralized service or computer system. The local device 32 preferably has computer readable media on which may be stored operating software and other software. The computer readable media may also store the temporary transaction number. Where the local device 32 is to transmit user identification information such as biometric data of the user, the local device includes the appropriate camera, fingerprint scanner, iris or retina scanner, or other input device for obtaining the biometric data, or may include an input via which such data may be provided.

The local device 32 may be a connected either wirelessly or via wired connection to a centralized service 34 through a communication link 36. The communication link 36 may be a computer network, the Internet, a telephone link or other communication means.

The centralized hosting service 34 in one embodiment is a computer system or computer server or may be multiple servers. The centralized hosting service 34 may be at a single location or distributed over several locations. The centralized hosting service 24 also includes computer readable media on which is stored software, including software for generating and/or storing the temporary transaction numbers. The centralized hosting service 34 is connected to the communication link 36 to receive the request from the local device 32. The local device 32 sends a request for the number as well as any limits or restrictions on the use of the temporary number. The local device 32 may also send personal identification information to the centralized hosting service 34 by which the intended user of the temporary number may be identified.

The centralized hosting service 34 of the illustrated embodiment generates the temporary transaction number. The temporary number is unique and incorporates or is linked to the limits added by the user as well as the intended user identification information. The temporary transaction number is stored, for example in a database, on the centralized hosting service storage medium and/or is transmitted for storage at an authenticating service 38 via a communication link 40. The temporary transaction number is also transmitted back to the local device 32 by the hosting service 34.

The local device 32 receives the temporary transaction number and provides the temporary transaction number to a carrier medium 42. The carrier medium 42 may be a piece of paper, plastic or other printable material on which the number is printed, such as by a printer connected to the local device 32. The carrier medium may be an electrically or electromagnetically recordable and readable media, such as a magnetic strip on a card or a solid state memory store. The carrier medium 42 may be a portable electronic device, such as a mobile telephone, personal data assistance, email device or other device on which the number is stored as data, and on which the number is potentially displayed such as on a display screen of the device. The carrier medium 42 may include electronic storage or computer readable media on which the number is stored for electronic transmission via a network connection, for example, when the temporary number is transmitted to a seller for an on-line purchase, for example. For instance, the local device may be a computer and the temporary transaction number is being used for payment for an on-line purchase by transmitting the temporary number via an on-line connection The means by which the local device 32 provides the number to the carrier media 42 is referenced 44 and encompasses the examples set forth above.

The user or other person authorized by the user seeks to pay for goods or services or otherwise make a financial transaction using the temporary transaction number. For example, the user brings the carrier medium 42 to a store to pay for a purchase. Payment for the goods or services, or other financial transaction is initiated by the user or other person presenting carrier medium 42 with the temporary number to the seller, as indicated by the arrow 46. The carrier medium 42 is read in the illustrated example by a reader device 48. The reader device 48 may include an optical reader for bar codes or grid codes, an optical reader with character recognition for characters as the number, an electrical or electromagnetic reader for carriers using electrical or electromagnetic storage, a wired or wireless reader of data stored on the carrier, or a manual input for the temporary transaction number.

The reader device 48 also includes an input for information concerning the purchase or other financial transaction. The input may include a keypad or keyboard for inputting price information and other information, a scanner for scanning products to be purchased, or other input for purchase or transaction information. The reader device 48 preferably also has an input for identification information of the user or other person using the temporary transaction number. For example, biometric information such as fingerprint scanning, iris or retina scanning, facial recognition, voice recognition, or identification information such as from an identification card such as a driver's license or the like, or user identification name and password information, address data or telephone number information or other information, may be used for identifying the user. The reader device 48 when used with such biometric information includes appropriate scanners, optics or other devices for obtaining this information from the user or other authorized person.

Some or all of the information relating to the limits imposed on the temporary transaction number may be known to the system, such as time and date information, so this information need not be input at the reader device 48 for the transaction. This information is used where the limitations on the use of the number are for certain periods of time or for certain days of the week or certain dates. Other information concerning a specific seller, or a type of business seeking authorization for the payment or types of goods or services for which the payment is sought may be already stored in the reader device 48 or may be input as part of the transaction process. The transaction number may be limited as authorized only for certain classes of business and so information on the type of business is transmitted by the reader device. For example, where a parent sends a temporary transaction number to his child for purchase of college textbooks, the transaction number is authorized for use by the child in the college store or any local book stores, but is not authorized for use by the child for purchases at the local pizza pub or other non-bookstores. In this example, bookstores are the permitted business type and this limit information is applied to or linked to the transaction number. In other examples, the limits identify prohibited business types instead, and the prohibited business types are applied to or linked to the transaction number.

A communication link 50 from the reader device 48 carries the authorization request to the authentication service 38. The authentication service 38, which may be separate from the central hosting service 34 or may be a part of the same device or system, checks the temporary transaction number for validity. In addition to checking that the number is valid, it also checks the limits that are imposed on the number to ensure that the purchase is within the limits. For instance, the purchase must be within permitted purchase amount, submitted within the permitted time period, submitted by the permitted seller or permitted type of seller, not submitted by a prohibited seller, and/or within other limits or restrictions. The authentication service 38 may also verify the identity of the user or of the other authorized person using the identification information forwarded by the reader device 48. The user identification information may be stored in the authentication service 38 where it is linked to the temporary number.

Once the authenticating service 38 has determined that the purchase or financial transaction is valid and within the limits or restrictions, an authorization is forwarded to the reader device 48. The goods or services purchased by the user or other authorized person are now paid for. The reader device 48 may send a confirmation that the financial transaction has occurred to the authenticating service 38. The authenticating service 38 sends information on the purchase or other financial transaction to a user account 52 via a communication link 54 where the purchase is applied against the account. The user account 52 may be a bank account, a credit card account, mobile telephone account, utility account, or other account or payment service.

The financial transaction has been carried out without disclosure of the user's credit card information or bank information yet the purchase is applied to the user's credit card account or bank account. Theft of credit card information or bank information at a restaurant or retail store is thereby avoided. On-line purchases made using the temporary transaction number avoid transmittal of the credit card information and so avoid possible theft of the credit card information.

The temporary transaction number may take different forms. For example, it may simply be a string of number characters, it may be made up letters and/or other characters, it may include both numbers and letters and/or other characters. For purposes of the present invention, the temporary transaction number includes non-number characters. The temporary transaction number may simply be a unique number used for this purpose. Preferably, the number encodes or is otherwise linked to the additional information used in the transaction, including user identification information and/or limit information. The link to the additional information may also be provided in whole or in part by linking the number to information stored in the authentication service, such as by links in a database for example stored in a computer server of the authentication service.

In an alternate embodiment, external authorization rules are applied. A confirmation number or text message address is inserted that requires a specific response to confirm a transaction. A user would insert something like “call 312 258 5785 and prompt for DTMF digits “1234” for confirmation of purchase” or “call 312 258 5785 and confirm that a previously recorded voice file “purchase confirmed” is spoken (speaker dependent voice confirmation)” Or an SMS text is sent reading “purchase stereo confirmation” to 3125551212 and wait for SMS text confirmation “yesok.” These elements could be embedded in the transaction string to allow users to provide external confirmation of authorization for a particular purchase, all encapsulated in the transaction number. The means of setting up these confirmation mechanisms may be a web form, or a PDA (personal data assistant) or intelligent mobile telephone. In this case, the system would automatically prompt on the device for the confirmation code when the encoded transaction ID or code is activated.

When the method is invoked, it would prompt to the third party location or telephone or on the device itself, operating as a secondary confirmation, or as a (dynamic) PIN on a debit card.

The user could control if the confirmation was at a second location, or time separated, that is the confirmation could occur at a different time than the original transaction, allowing time for delivery or satisfaction of a condition.

The present invention thus provides a method and apparatus for performing commercial transactions and other financial transactions using temporary transaction codes. A software program or hardware or combination thereof is provided to generate a temporary financial transaction identification number. The software program, hardware or firmware for generation of the number in whole or in part can be provided on a user's computer, on a store or business computer or other computer device or system, on a kiosk or terminal at a business, or on a personal electronic device, such as a mobile telephone, smart phone, personal data assistant, email device, or other personal electronic device or other local device. In another embodiment, the temporary financial transaction number is generated in whole or in part by a central computer system and is transmitted to the user, and in a further embodiment the temporary number has previously been generated and stored on one or more central hosting systems and a user requests the number from a central system.

The temporary transaction identification number is sufficiently long enough to provide assurance of a level of uniqueness for the number. For example, a 32 character “number” provides sufficient possibilities to ensure that the transaction number is both unique, and thus not confused with other transaction numbers, and so that it can encode additional specific data elements to make it possible to encode restrictions and identification information in the number. Longer numbers, such as 64 digit numbers or 128 digit numbers, are also possible, and the use of number bases greater than 10 can increase information density. In the example given, a number base consisting of 36 characters (0123456789ABCDEFGHIJKLMNOPQRSTUVWXYZ) makes it possible to encode a very large amount of information in just 32 characters.

The software for generating the number locally or for requesting the number from a central hosting system may be provided to the user as a download to the user's computer or mobile telephone or other local device. Other means for providing the number generating or requesting software may also be provided, such as via computer readable memory, such as disks, solid state memory or other media distributed to the user, or it may already be installed on the computer, phone or other device when purchased. Where the temporary transaction number is requested from a central host system, either as a previously generated number or a request for generating a new number by the central system, the risk of tampering that may be possible in a system using a locally generated number is reduced. A higher level of security is thereby possible.

Each temporary number is unique. Randomly generated numbers or other unique numbers are used to ensure that the same number is never repeated. The randomly generated number or other unique number may be used as the base to which is applied the limit data and identification data. The use of a one time pad, combined with a sequence number, can provide an essentially unassailable and secure transaction number. A one time pad, however, requires the ability to generate a large amount of random data. Truly random data is “unbreakable” encryption. The incrementing sequence number appended to these values assures that in the very unlikely event that two random numbers selected from the pad might be the same values, the increment serves as a tied breaker.

A possible source of the random numbers for the temporary number, or the base of the temporary number, is by hardware random number generators that rely upon crystal oscillation and thermal noise, and another source is a random number generator built into some newer Intel processors that incorporate a random number generator component. In an example, the processor uses a random source that is derived from two free-running oscillators, one fast and one much slower. A thermal noise source is used to modulate the frequency of the slower clock. The variable, noise-modulated slower clock is used to trigger measurements of the fast clock. Drift between the two clocks thus provides the source of random binary digits. Similar random number generator designs using independent oscillators are well known and may be used here.

Also, one potential method is to create the numbers on-line or with a phone call which would then send out the transaction number as a URL (uniform resource locator) or as a number sent back to the user. The local device could then add the attributes of use and send in that number with the requested payment details, which the system would then verify as conformed to the limits set on the number originally, and then the system would release the funds, or push directly to the customer or a device in the store.

The centrally generated number may incorporate restrictions or limit data and identification data in the number as the result of such data being received centrally from a local requester. The money part of the transaction is preferably the result of the centrally provided number, for example the base number. The local system may download and store one or more centrally generated numbers and issue the numbers to the user on demand along with restrictions, identification (such as frequent buyer numbers) or other criteria. The restrictions may be encoded in or added to the number by the local device when the user requests a new number.

A different temporary number is generated by the software or provided to the user each time a request is made for a number. Preferably, the same number cannot be issued twice. The number is dynamic rather than static as for credit card account numbers. In other words, a different number is generated or forwarded each time the user requests a number. The numbers may also be considered as transient numbers. The temporary number may expire after a single, after a shortened period of days or weeks, or after some other time period or other condition has occurred. The transient number in one embodiment exists or is valid during the period of time that it is being used. The temporary number in one embodiment has a limited lifetime such as for a limited time offer as an inducement for the user to use the number sooner, for example. The temporary number may also hold a predetermined value, for example, for a specific purpose without a limit on the time it is valid, or there may be a limit of a few years imposed on the validity of the number.

The request for a new number and the transmittal of the new number to the local device or authorization for the new number from the validating authority to the local device are transmitted by secure communications. The communication links employ known means and methods to ensure that data is not lost or compromised. The local device authenticates and connects to one or more secure host sites for the number and/or authentication request.

The user inputs limits or other restrictions or criteria to be applied to or linked to the temporary number using the local device. The limits may be dollar limits, an expiration time or date, valid times of day for use, valid days of the week or valid dates for use, valid users of the number, valid recipients or types of recipients of the number, for example. The limits may also block use at certain sellers, for instance the temporary number may be valid for use in bookstores and grocery stores, but not at liquor stores. The limits may permit or prohibit payment for certain goods or services or classes of goods. The temporary number, whether centrally generated or locally generated, may have a base to which is supplied additional numbers or encoding that indicates the user defined limits. The embedded information may be as added digits, an encoding of the base number digits, or other encoding or embedding scheme. The local software may also add user biometric information or other features to the temporary transaction number.

The temporary financial transaction number is backed by a credit card account, bank account, cash payment, mobile telephone account, utility account, or other financial vehicle or account. An exchange between the computer or phone generating or requesting the number and the validating entity validates the code for printing on the sheet of paper, on a coupon, or for display on the mobile phone display. Unlike the credit card or bank account, the user sets user limits on the temporary financial transaction number when the number is issued. The user designated limits may include a limit on the amount per transaction, a limit on the total amount authorized, a time limit, a limit on the type of stores or services, or a limit on the specific store. The temporary number is generally limited to use by a particular individual, although a group of people, for example, the employees of a company or members of a family, may be designated as approved users.

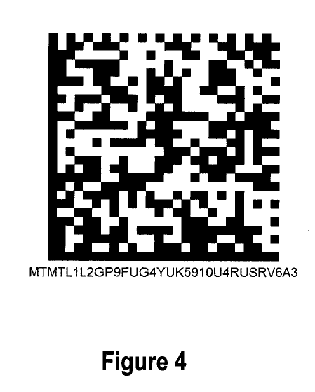

A variety of carrier media for storing the temporary number is possible. The temporary financial transaction number may be printed on a paper print out from the user's computer or from a store computer. The print out may be on a standard paper size, or may be sized and formatted like a coupon or credit card so that it can be easily carried. The print out may be formatted to permit the user to cut a credit card or coupon-sized portion containing the number from the larger page. The temporary financial transaction number may be set forth as a number or character string, as a machine readable code, or both. For example, a two-dimensional grid code is preferably printed on the paper, since a greater amount of information may be encoded in the grid code in a relatively small area. One example of a grid code is Semacode, as shown in FIG. 4. The illustrated grid code encodes the URL http://secvec.com/MTMTL1L2GP9FUG4YUK5910U4RUSRV6A3, where the number is a 32 digit base 36 number. Thus, the temporary transaction number may include an Internet address or other address at which validation can be requested or via which validation is obtained. A bar code or other one or two dimensional machine readable code may be provided instead. Other known encoding means may be provided for encoding the transaction number. The number may also be modulated or otherwise processed.

Another format for the carrier for the number is a credit card shaped and sized card. The temporary financial transaction number is shown on the card, or provided on the card as a machine readable code, or both. The card may be formed of plastic, paper, card stock, coated paper, or other materials and may be generated by a special apparatus, or by punching out a card shaped portion from a larger sheet fed through a printer. The card may have the appearance of a credit card, including a number, user name, logo and possibly even a magnetic stripe on the back or a wirelessly readable storage.

Another format is the use of electronic paper, which is capable of receiving an image from electrical signals, and can retain the image until another electric signal erases the image. Other display devices are included.

Another possibility is that the temporary financial transaction number may be provided for display on a display screen of a mobile telephone, for example, or other portable electronic device. The number may be displayed as a number, as machine readable code, or both, on the mobile device display screen. The user points the display of the mobile telephone or other device toward a scanner at the store, for example, so that the scanner may read the code shown on the display to make the payment. Several temporary transaction numbers may be stored in the carrier medium.

The temporary financial transaction number or code can be transmitted to the mobile telephone from an outside source or can be generated by software in the telephone. The mobile telephone may have the additional functionality of being capable of generating the numbers or codes as a feature of the phone. A devices that serves as a mobile telephone is also possible, including a personal data assistants (PDA), email device such as a Blackberry device, or other multifunctional electronic device.

It is also foreseen that a purpose built device may be provided as the number carrier. In other words, the electronic device serves primarily as the carrier for one or more temporary transaction numbers. The device may be programmable or not and may have an input/output connector or some other input/output means. Such a device may serve only as a carrier for the transaction number. A computational apparatus, such as a PC, mobile telephone, PDA or the like, may be used to interact with the device and provide a user interface.

Reading the number or code from the carrier media may be via wired connection such as by plugging into a connector, by wireless transmission such as by a radio frequency signal, or by a visual scan for example using a laser scanner or other optical reader. A possibility is that the media on which the temporary financial transaction number is provided may be a memory chip, micro-drive, magnetic strip, or circuit capable of storing a number or code. For example, a so-called flash drive that includes one or more memory chips or miniature hard drives in a small portable housing with a USB connector for plugging into a computer device may store the temporary number. Memory devices are becoming ever smaller and connectors for reading such memory devices are likewise becoming smaller, including so-called mini-USB connectors, connector slots for reading compact flash memory, SD memory, mini SD memory, xD memory and other memory formats. All of these and others may be used to carry the number.

It is also possible that the temporary number could be stored on a magnetic strip of a traditional credit card. This enables readily available credit card readers found in many stores and restaurants to be used to read the number either using existing equipment and communication channels or by only slight changes in the equipment to permit reading of longer numbers or additional codes, and the like.

In another example, a wireless transceiver, such as an RFID device, or radio frequency identification device, may store the number. The devices may be passive or active, in other words internally powered with a battery or only being powered by received power. One example of an RFID device is a very small solid state device that can store 128 bits (32 decimal digits using hexadecimal encoding), is passive, has a unique number, and is read by an interrogation signal. Such as device is shown at: http://www.technology.com/ct/Science-Fiction-News.asp?NewsNum=939 Using such an RFID device, the response by the device to the interrogation is used to access an address of a computer system where the temporary transaction is stored. Other account information, attributes, or additional information may also be stored there.

It is foreseeable to use Bluetooth technology to transfer the unique temporary transaction number between the carrier and a reader. Other wireless communications technology may be used as well.

Two devices may be used, a computer based number generator and a static machine readable device, such as an RFID device. Computational devices so small that they must be connected to an input/output kit may be used to carry the number. The input/output kit may include a wireless connection or wired connector.

The holder of the temporary transaction number is able to perform financial transactions using the number, such as purchasing goods in a store, pay for admission to an event, pay bills, pay for restaurant meals, or other transactions. The financial transactions are performed by presenting the transaction number and/or machine readable code to the store, restaurant or other entity for acceptance. The temporary number is also used for on-line purchases and transactions.

When the temporary number or the code embedded with the number is presented to a business to purchase goods or services, or is used to pay for other financial transactions as well, the temporary number must be validated. The number is validated by the business in the same or similar way that a credit card account number is validated, by transmitting the number and request to validate the number and purchase amount to an authorizing entity, for example. The authorization may be through the same channels as used for credit card authorizations or through different channels. Both the communications for issuing the number to the user and for authorization of purchases by the user are preferably encrypted for security. MD5 hash security may be used. Preferably, the authorization for the charges is stored at a redundant data facility.

The user may be required to present an identification when using the temporary number. In addition to standard identification schemes, such as requesting a picture ID or drivers license, the print out with the temporary number or encoded number may include biometric data of the authorized user. Such biometric data can include eye color and hair color, or somewhat more specific information such as iris scan or retina scan data or fingerprint data. Another validation means possible with the present number is through use of a personal identification number, or PIN, that is entered by the user when the temporary number is presented for use. The PIN number can be entered by the user on an apparatus provided by the store or business or may be entered on the user's mobile telephone. The additional identification tools may be encoded in the machine readable code.

For high value transactions, a security pass code may be required for use of the temporary number. For example, an RSA pass code or other code generated by a separate apparatus or entity may be required.

An authorized use of the temporary financial transaction number appears as a charge against the credit card account that backs the number, or a withdrawal from the bank account. In another embodiment, the transaction appears as a charge on the mobile telephone bill or other utility bill of the user. The use of the temporary number tracks back to the account or entity that authorized the issuance of the number. Other entities can authorize the temporary numbers, including utility companies, investment companies, or other entities so that purchases may be withdrawn from or applied to a variety of sources. Other means of billing for the transaction or of backing the transaction are also included in the present invention.

In one example, a user uses software on the user's computer or mobile telephone to retrieve and or generate a temporary financial transaction number for a night on the town. A dollar amount is set and a limitation is imposed to permit use only for the next 6 hours, for example. The user has dinner at a restaurant and pays for the meal using the temporary financial transaction number encoded in a two dimensional grid code that the user has either printed on a piece of paper or which is displayed on the user's mobile telephone screen. The grid code is scanned by personnel at the restaurant and an electronic request for authorization of the number and purchase amount is transmitted to an authorizing entity by the restaurant. An authorizing entity notifies the restaurant that the code is valid for the requested amount and by the requesting user, so that the payment is approved. The cost of the meal is charged to the user's credit card, but without the restaurant personnel learning the user's credit card number. Loss of the number or misappropriation of the number does not expose the credit card account to use outside the limits set by the user.

Another example is a parent that requests a temporary number from a central database or other repository or requests that a new number be generated by a central number generating apparatus for use by a child who is away at school so that the child may make purchases against the number at the school bookstore, grocery stores, and perhaps a movie theater. Neither that child nor anyone else can use the number for purchases at unauthorized vendors. The number may be limited only to purchases made before 8 pm, to ensure that a school curfew is enforced, for example.

Another use is for payment for on-line purchases, where the temporary number is transmitted to the seller instead of the user's credit card number. The user generates or requests a temporary number that has a dollar limit set at the price of the on-line purchase, so that no use of the number beyond that limit is authorized. The temporary number may be generated or requested while the user is in the process of making the on-line purchase, for example, by pausing during the on-line purchase process to obtain the number and then inputting the number to complete the on-line purchase. The temporary number may include a limit on the dollar amount of the on-line purchase and limited to the seller for the on-line purchase.

The temporary financial transaction number permits a user to present the number to a store to purchase items at the store, for example, without revealing the user's credit card number or bank account number. Only the temporary number is revealed. Thus, a layer of protection is provided to shield against unauthorized disclosure and/or use of the credit card number, bank account number or other personal information.

Limitations imposed on the temporary financial transaction number enable the user to limit risk. For example, a user may designate a dollar amount as the limit on the purchases possible against the temporary number, so that the user may, for example, more easily stay within a budget or avoid spur of the moment purchases. The user may provide the dollar limited number to a child so that spending by the child is controlled. The child may be sent to the store to purchase $25 in goods and the parent can provide a temporary number that limits the purchase amount to $25, or maybe $30 in case the items cost more than predicted, thereby ensuring against purchase of other items by the child, as well against lost of a credit card by the child.

Loss of the temporary number limits losses to the dollar limit set on the number. If the child looses the temporary number with the $25 limit, the limit of the loss is $25. If the child has already purchased the goods using the number but leaves behind the print out showing the number, the number is of little or no value to the finder, resulting in little or no loss for the parent. This is vastly different to the cost and trouble of loss and replacement of a credit card.

The user may in some embodiments be permitted to recharge the temporary number, i.e. raise the authorized purchase amount, to permit additional purchases to be made against the number. Or the user may change the parameters or limits on the use of the number, adding possible users or possible vendors.

The temporary number may limit transactions to a particular vendor or a period of time, or to a particular person, or to a particular use. The temporary number may be applied to a particular vendor, such as a food delivery service, such as a pizza delivery company, to permit use only for purchases from that vendor.

Thus, a dynamic financial transaction number is provided, that shields personal information of the user from the vendor that accepts the number during a transaction. A temporary financial transaction number is generated for conducting a financial transaction, such as for paying for goods or services. The temporary number has limits on use, such as time, and amount limits and limits on the type of goods or services that may be purchased or on the type of business at which the purchase may be made. The limits may be encoded into the temporary number or otherwise linked to the number. User identification information, or information on other authorized users, may also be encoded into the number or otherwise linked to the number. When presented for a payment, the number is checked for validity as well as whether the purchase is within the limits. An authorized purchase is applied against a user bank account or credit card account without disclosure of the account information. The temporary number is printed or is displayed on a display of a portable electronic device for presentation to the seller, or is transmitted to the seller for on-line purchases.

Although other modifications and changes may be suggested by those skilled in the art, it is the intention of the inventors to embody within the patent warranted hereon all changes and modifications as reasonably and properly come within the scope of their contribution to the art.

I claim:

1. A method for conducting a financial transaction, comprising the steps of:
generating a temporary transaction number, said temporary transaction number including a unique number as base number, said step of generating the temporary transaction number being performed by a number generator device;
applying user defined limits to the temporary transaction number;
associating the temporary transaction number with a user account;
receiving the temporary transaction number by a seller as payment for a purchase;
checking validity of the temporary transaction number and checking whether the purchase is within the user defined limits using a computer system;
authorizing the payment to the seller if the temporary transaction number is valid and the purchase is within the user defined limits; and
applying the purchase against the user account if the payment is authorized.

2. A method as claimed in claim 1, wherein said limits include user defined limits on time during which an authorized purchase may be made.

3. A method as claimed in claim 1, wherein said limits include user defined limits on sellers from which an authorized purchase may be made.

4. A method as claimed in claim 1, wherein said limits include a user defined limit on an amount of an authorized purchase that may be made.

5. A method as claimed in claim 1, further comprising the steps of:
generating a graphical code element corresponding to the temporary financial transaction number; and
said step of submitting including displaying the graphical code element for reading by the seller.

6. A method as claimed in claim 5, wherein said graphical code element is a two dimensional grid code.

7. A method as claimed in claim 1, wherein said step of applying user defined limits includes incorporating data encoding the limits into the temporary transaction number.

8. A method as claimed in claim 1, further comprising the step of:
applying identification data to the temporary transaction number.

9. A method as claimed in claim 8, wherein said step of applying identification data includes encoding the identification data into the temporary transaction number.

10. A method as claimed in claim 9, wherein limit data and identification data are encoded into the temporary transaction number.

11. A financial transaction apparatus for conducting a financial transaction, comprising:
a temporary financial transaction number generator having a request input for receiving a request for a temporary financial transaction number and for receiving user defined limits for a financial transaction authorized by the temporary financial transaction number, said temporary financial transaction number generator an output for outputting the temporary financial transaction number encoded with the limits;
an authorization component connected to receive requests for authorization to use the temporary financial transaction number, said authorization component connected for communication with a user account associated with the temporary financial transaction number, said authorization component being operable to determine if a request for use of the temporary transaction number for a purchase is within the user defined limits;
a reader having an input for receiving the temporary financial transaction number as payment for a purchase, said reader being connected to said authorization component to send an authorization request for the purchase to the authorization component, said reader being connected to receive an authorization for the purchase from the authorization component if the authorization component determines that the purchase is within the user defined limits; and
said authorization component being operable to apply the purchase amount to the user account upon if the purchase is determined to be within the limits.

12. A financial transaction apparatus as claimed in claim 11, further comprising:
a biometric data reader connected to said reader and operable to read biometric data of a purchaser and transfer the biometric data as identifying data to the authorization component; and
wherein said authorization component is operable to compare the biometric data received from said biometric data reader to biometric data associated with the temporary financial transaction number.

13. A financial transaction apparatus as claimed in claim 11, further comprising:
a carrier medium structured to receive said temporary financial transaction number from the temporary financial transaction number generator and structured to provide the temporary financial transaction number so said reader.

14. A financial transaction apparatus as claimed in claim 13, wherein said carrier medium includes a card on which is applied a grid code encoding the temporary financial transaction number.

15. A financial transaction apparatus as claimed in claim 13, wherein said carrier medium includes a portable electronic device having a display on which is displayed the temporary financial transaction number.

16. A financial transaction apparatus as claimed in claim 15, wherein said portable electronic device is a mobile telephone.

17. A financial transaction apparatus as claimed in claim 13, wherein said carrier medium includes a electronic storage structured for reading by said reader.
